(19) United States
(12) Patent Application Publication
(10) Pub. No.: US 2025/0244174 A1
(43) Pub. Date: Jul. 31, 2025

(54) RAMAN SPECTROSCOPY METHOD WITH SINGLE-CHANNEL DETECTION WITHOUT A DISPERSION ELEMENT, AND DEVICE FOR IMPLEMENTING THE METHOD

(71) Applicant: HUN-REN WIGNER FIZIKAI KUTATÓKÖZPONT, Budapest (HU)

(72) Inventors: Miklós VERES, Biatorbagy (HU); Istvan RIGO, Bicske (HU); Tamas Attila VACZI, Budapest (HU); Peter FORJES, Budaors (HU)

(21) Appl. No.: 18/858,466

(22) PCT Filed: Apr. 20, 2023
(86) PCT No.: PCT/HU2023/050019

§ 371 Date: Oct. 21, 2024

(30) Foreign Application Priority Data
Apr. 21, 2022 (HU) P2200127

(51) Int. Cl. G01J 3/44; G01J 3/433

(52) U.S. Cl. CPC G01J 3/44; G01J 3/433; G01J 2003/4332

(57) ABSTRACT

A Raman spectroscopic method is described using single-channel detection without dispersion element, where the spectral components of a monochromatic excitation beam having spectral bandwidth covering the spectral range of the Raman shift to be measured are modulated with different frequencies in the range 100 Hz-10 MHz, the time variation of the Raman scattering excited by this beam is detected through a narrow-band spectral bandpass filter transmitting only the Raman scattered light excited by those components of the excitation beam for which the Raman shift falls just within the transmission wavelength range of the filter, and the so measured signal is Fourier transformed to reproduce the Raman spectrum with a high spectral resolution, typically below half a wavenumber. The device implementing the method uses an excitation laser light source (1) with a spectral bandwidth covering the spectral range of the Raman shifts to be measured, a modulator (7) modulating the different wavelength components of the monochromatic laser light beam (2) emitted by the light source (1) at different frequencies, optical system directing the modulated laser light to a sample (8) and collecting the light scattered by the sample (8), a single-channel detector (9) sampling the scattered light intensity with frequency being at least twice the maxi-mum modulation frequency, and a bandpass filter (10) with a spectral bandwidth being nar-rower than the excitation laser beam (2) and transmitting the spectral range of the Raman shifts to be measured, wherein the bandpass filter (10) is arranged before the detector (9) and has an arithmetic unit reproducing a Raman spectrum with high spectral resolution by performing a Fourier transform on the measured signal.

The invention relates to a Raman spectroscopy method with single-channel detection without a dispersion element, during which the spectrum of light scattered by a change in wavelength from a sample excited by monochromatic light is detected. The invention also relates to a device for implementing the method, comprising a laser light source producing a monochromatic light beam, and optical elements influencing the path of the produced laser light beam.

Raman spectroscopy is a widely used optical spectroscopy technique that detects the spectrum of light scattered inelastically (i.e., by changing the wavelength) from a sample excited with monochromatic light. The method detects the characteristic vibrations (molecular vibrations) of the sample and thus allows the identification of functional groups (in the case of molecules) and the complete structure. Its applications range from mineral analysis, through manufacturing quality assurance and biological materials, to medical diagnostics and many areas of modern technology.

In Raman measurement, the sample to be measured is illuminated by a laser beam, the scattered light is collected by a suitable optical system and fed into a spectrometer. In the spectrometer, the light is resolved by wavelength using a dispersion element, which can be an optical grating or a prism. The essential feature of the known technique is that the intensity of the scattered light is not measured at the wavelength of the excitation laser, the latter is filtered out of the measured Raman spectrum by using a suitable filter or a spectrometer with sufficiently high resolution. The Raman spectra and Raman peak positions are represented in relative wavenumber units, which are

$${v}_{Raman} = {v}_{Laser - abs .} - {v}_{Raman - abs .}$$

where v_{Raman} is the relative wavenumber of the Raman shift, v_{Laser-abs.} is the absolute wavenumber of the excitation laser, and v_{Raman-abs}, is the absolute wavenumber of the Raman shift. Thus, for example, a Raman band at a relative wavenumber of 500 cm⁻¹ is found when using a 785 nm excitation laser (whose absolute wavenumber is 12739 cm⁻¹) at an absolute wavenumber of 12739−500=12239 cm⁻¹. The Raman spectrometer measures the absolute wavenumber, and the Raman shift can be calculated from the above formula using the laser wavenumber.

A further important feature of Raman scattering for the device according to the invention is that the relative position of the Raman bands observed in the spectrum with respect to the wavenumber of the excitation laser is constant, i.e., when the wavelength of the excitation laser beam is changed, the position of the Raman band in absolute wavenumber also changes. In the example above, if the Raman band at 500 cm⁻¹ is excited by a laser at 800 nm instead of 785 nm, the Raman band will appear at an absolute wavenumber of 12500−500=12000 cm⁻¹. The difference between the wavenumber of the excitation laser and the absolute wavenumber of the Raman peak measured by the spectrometer will always be 500 cm⁻¹.

U.S. Pat. No. 7,327,453 B2 discloses a method and system for Raman spectrum detection in which a sample is illuminated with an excitation light beam and a detector system is used to detect the Raman spectral response of the sample through an aperture while shifting the Raman spectrum relative to the detector system. The Raman spectral responses are combined into a composite spectrum and the aperture image of the composite spectrum is obtained by deconvolution on the detector array.

U.S. Pat. No. 8,514,394 B2 describes a spectrograph with multiple excitation wavelength ranges for use in Raman spectroscopy. The spectrograph includes a wavelength switching structure for switching between different wavelength ranges corresponding to the wavelength of the incoming light beam. The wavelength switching structure comprises a plurality of optical units corresponding to different wavelength ranges for processing the incoming beam. The structure also comprises a switching element for switching the optical units to match the corresponding structure to the incoming beam. Each optical unit comprises one or more transmission gratings for splitting the incoming light signal into a plurality of wavelengths within a given wavelength range, and a reflecting mirror arranged in the vicinity of the grating(s) for reflecting light of different wavelengths through the one or more gratings to photodetectors for wavelength measurement to form a spectrum.

Since the efficiency of Raman scattering is low and the energy of the excited vibrations is small, Raman spectrometers use high-sensitivity, mostly multi-channel detection, excitation light sources with small bandwidth and high-resolution spectrometers. For all these reasons, a high-resolution Raman spectrometer is large and expensive. Compact instruments with lower resolution and lower sensitivity are available but are not suitable for detecting small changes in the position of Raman bands. For these reasons, although there is a demand for them, high-resolution Raman spectrometers are not widely used in industry.

Our study aims to fill this gap. We have recognized that the best way to achieve this is to create a method and a device capable of implementing it, where the dispersion element, which has been used predominantly in the detector branch, is omitted. This change allows the construction of a compact, high-resolution Raman spectrometer.

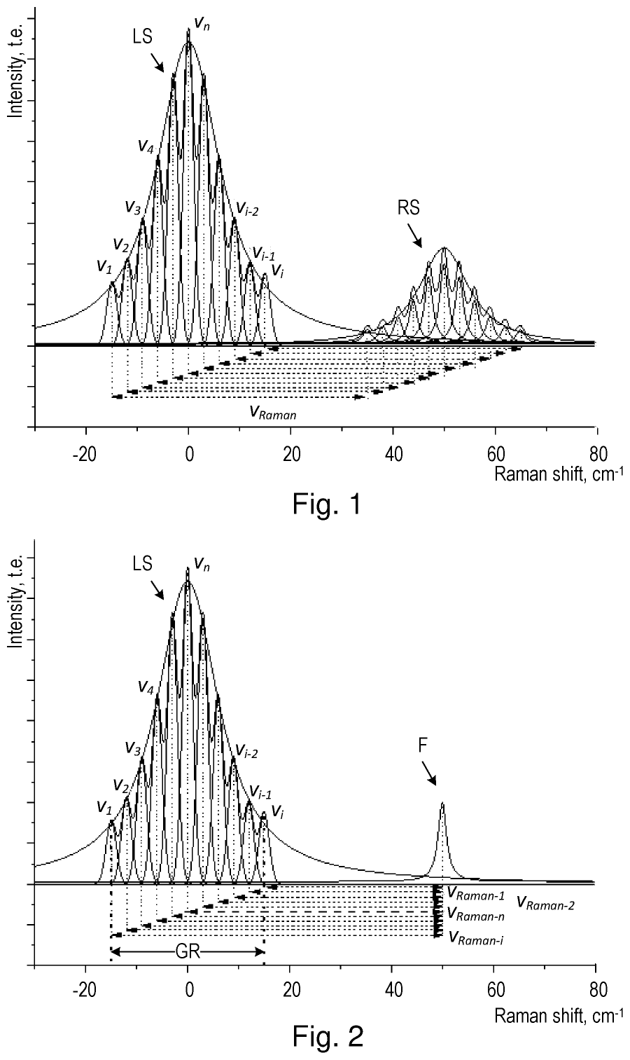

Based on this insight, the method we have developed exploits the property of Raman scattering described above, i.e., that the Raman shift of a given peak is always the same wavenumber from the excitation laser wavenumber, a known property that is shown in the schematic of FIG. 1. Lasers that are considered monochromatic have a spectral bandwidth, i.e., the light they emit covers a defined range of wavenumbers. If the LS spectrum of the laser, indicated by the peak on the left of FIG. 1, is decomposed into v₁, v₂, v₃, . . . vᵢ₋₁, vᵢ components, similar components can be observed in the RS Raman band, indicated by the peak on the right of FIG. 1, when measured spectroscopically, since the shift of the Raman band in relative wavenumber, indicated by the black dotted arrows in the lower part of FIG. 1, will be the same for each component.

If a small F bandpass filter with a spectral transmission bandwidth comparable to the bandwidth of the excitation laser exciting the GR Raman band is placed in front of the spectrometer in the light path, not all of the above Raman band components will reach the detector, but only the one excited by the vₙ component of the laser with respect to which the wavenumber of the bandpass filter is exactly equal to the wavenumber of the Raman band v_{Raman-n}, as defined in the second order of magnitude 2. indicated by the dashed arrow in FIG. 2. The other v_{Raman-1}, v_{Raman-2}, v_{Raman-3}, . . . v_{Raman-i-1}, v_{Raman-i} components are blocked by the bandpass filter. However, the other components of the excitation laser may excite Raman bands, if any, in the sample, whose scattered photons pass through the bandpass filter if their wavenumber, i.e., Raman shift, is equal to the difference between the wavenumber of the laser component and the wavenumber of the bandpass filter indicated by the dotted arrows in FIG. 2. Their Raman shifts will be different from the Raman band of v_{Raman-n}, indicated by the dashed thick line above. Thus, when the bandpass filter is applied, the components of the laser with a given bandwidth will excite a small region of the Raman spectrum, each component a small part of this region. With a spectrometer, however, the spectrum thus excited can no longer be detected as a spectrum, because it will only see the wavenumber range of the light passing through the bandpass filter, in which all components of the excited Raman range are present simultaneously according to the above excitation mechanism. Its intensity can be measured with a single detector, i.e., the detection of Raman scattered light can be performed on a single channel without the use of a dispersion element, a spectrometer.

The task has been solved by a Raman spectroscopic method using single-channel detection without a dispersion element, which detects the spectrum of light scattered from a sample excited by monochromatic light as the wavelength changes. It is proposed
to modulate the spectral components of a monochromatic excitation beam with a spectral bandwidth covering the Raman shift spectral range to be measured at different frequencies between 100 Hz and 10 MHz,
detect the temporal variation of the Raman scattering excited by this beam behind a spectral bandpass filter with a bandwidth smaller than the spectral bandwidth of the excitation beam, which allows only the Raman scattered light of the wavelengths excited by the components of the excitation beam to pass through, where the Raman scattered light excited by the component falls within the passband of the filter, and
perform Fourier transformation on the measured signal to reproduce a Raman spectrum with a high spectral resolution, typically below half a wavenumber.

According to a preferred embodiment of the proposed method, to measure the spectrum and to separate the spectral components, each spectral component of the excitation light beam is distinguished such that
the excitation beam is split into its spectral components by an optical grating,
the light beam thus obtained, which contains light resolved in the horizontal direction according to the wavelength, is focused onto a disc on which reflecting and transmitting regions are alternately trained in concentric rings with different repetition periods, the disc is rotated, the components of the focused light beam are reflected or transmitted depending on the regions of the disc, and the intensity of the light beam is continuously and periodically modulated,
the components of the reflected light, which are the same as the incident beam but travel in the opposite direction, are combined with the optical grating to return an excitation laser beam that contains each spectral component modulated at a different frequency,
the Raman spectrum excited by the modulated output beam is passed through a bandpass filter,
the light beam transmitted through the bandpass filter is detected by a single-channel detector,
perform a Fourier transform on the time-domain signal emitted by the detector to extract the frequency components and their intensities in the Raman-scattered spectrum,
knowing the modulation frequencies associated with each component of the excitation laser beam, we determine the relative wavenumber Raman shifts associated with each component, and thus reconstruct the Raman spectrum.

On the other hand, the task was solved by a device for the realization of the Raman spectroscopic process according to the invention, consisting of
a laser light source with a spectral bandwidth covering the spectral range of the Raman shifts to be measured as a monochromatic excitation light source,
a modulator modulating the different wavelength components of the monochromatic laser beam emitted by the light source at different frequencies,
an optical unit that directs the modulated laser light to the sample and collects the scattered light reflected from the sample,
a bandpass filter with a spectral bandwidth much smaller than that of the excitation laser beam, where the bandpass filter is positioned in front of the detector, and which is transparent in the spectral range of the Raman shifts to be measured,
a single-channel detector sampling the scattered light at rate being at least twice the maximum modulation frequency,
an arithmetic unit that produces a Raman spectrum with high spectral resolution by performing a Fourier transform on the measured signal.

According to a preferred embodiment of the proposed device, the device comprises a beam splitter arranged in the path of the laser light beam produced by the light source, optical elements projecting the laser light beam exiting the beam splitter onto a pattern, optical elements for transmitting the scattered light reflected from the sample to a device for displaying/receiving the scattered spectrum, an optical quarter-wave plate for converting the linearly polarised light into a circularly polarised light is arranged downstream of the polarisation-dependent beam splitter connected to the output of the light source, an optical grating is arranged downstream of the optical quarter-wave plate in the path of the light to split the light into components according to wavelength, a lens is associated with the output of the optical grating to parallel the components that fan out, a modulator is arranged downstream of the lens to modulate the components of different wavelengths at different frequencies, a bandpass filter is arranged in the path of the light reflected from the sample and a single-channel detector is arranged downstream of the bandpass filter.

According to a further preferred embodiment of the proposed device, the modulator is arranged in concentric circles as a rotating disc composed of a different number of alternating reflective-non-reflective sections per circle.

In the latter case, it may be advantageous if the modulator is arranged in concentric circles as a rotating disk array of alternating transmissive and non-transmissive sections with different numbers of alternating transmissive and non-transmissive sections per circle.

For this design, it is advantageous if the modulator is designed as a parallel micromirror matrix tiltable at different frequencies per mirror, in particular as a parallel micromirror matrix tiltable at different frequencies per mirror.

According to a further preferred embodiment of the proposed device, the bandpass filter is implemented as any of a combination of an interference filter, a low-pass filter, a high-pass filter, a spectral domain filter, a photonic crystal, a virtually mapped phase matrix.

The invention is described in more detail below with the aid of example embodiments, with reference to the accompanying drawing, in which

FIGS. 1 and 2 show schematic Raman shift characteristic curves,

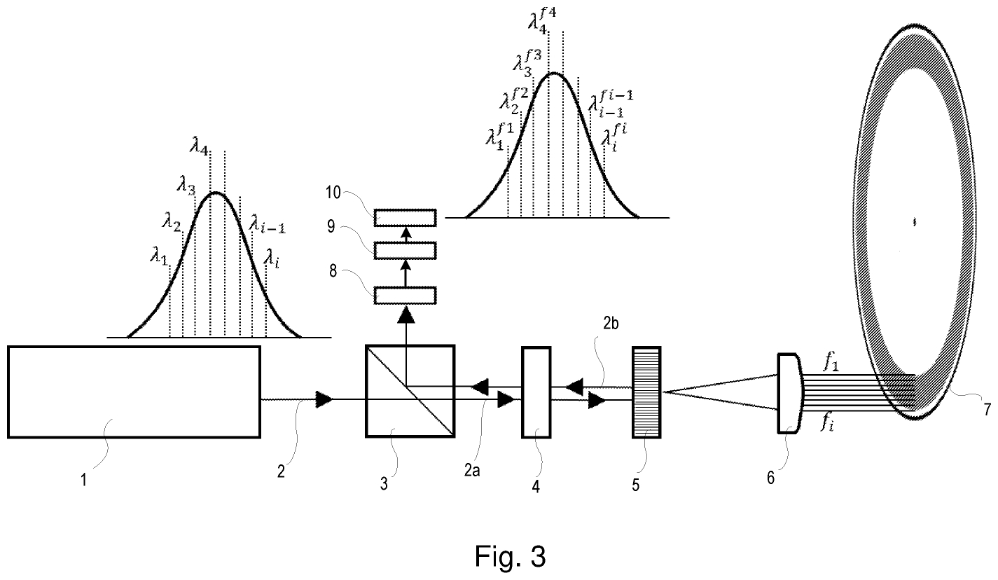

FIG. 3 shows a schematic embodiment of an example embodiment of a device according to the process of the invention, and

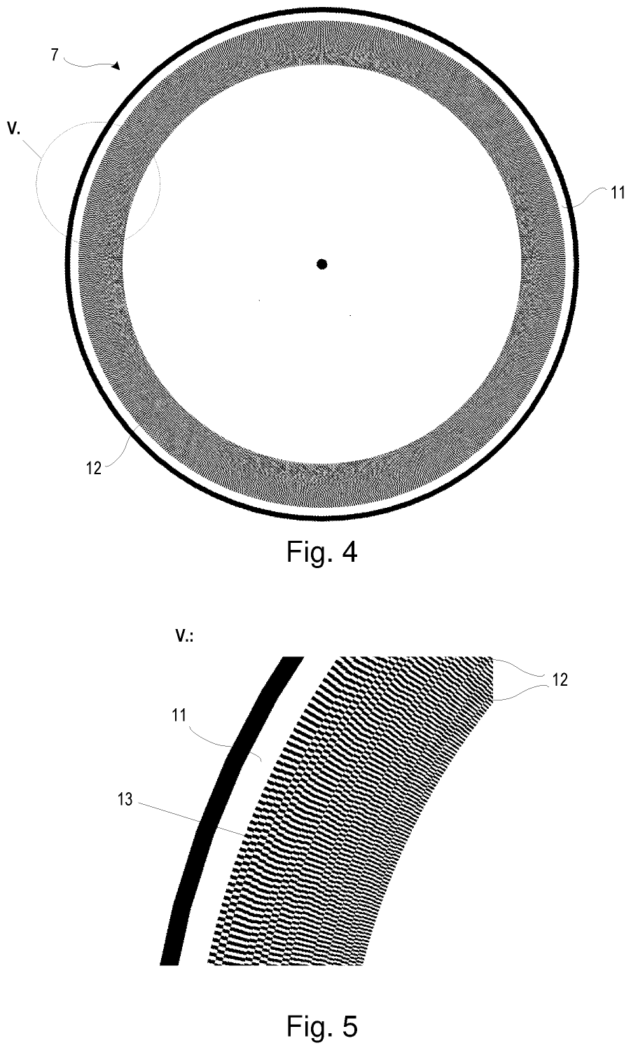

FIGS. 4-5 show a possible embodiment of a rotary disc modulator used in the device according to FIG. 3.

The basis of the state-of-the-art procedures is described in the introductory section with the help of FIGS. 1 and 2. FIG. 3 shows a schematic embodiment of an exemplary embodiment of a device according to the process of the invention. In an embodiment of the method according to the invention, considered as a merely preferred example, a monochromatic light beam 2 is produced by using a laser light source 1 with a known, suitable, i.e., spectral bandwidth capable of covering the spectral range of the Raman shifts to be measured and within that spectral range, a laser light source 1 having spectral components λ₁, λ₂, λ₃, . . . λᵢ₋₁, λᵢ. In the detection process, however, to measure the spectrum and separate the spectral components, some way of distinguishing the individual λ₁, λ₂, λ₃, . . . λᵢ₋₁, λᵢ spectral components of the excitation laser light beam 2 is required. To do this, the beams 2 are passed through a polarization-dependent beam splitter 3, which in this case transmits the vertically polarized light straight through, deflecting the horizontally polarized light by 90°. Downstream of the beam splitters 3 in the direction of travel of the beams 2, a quarter-wave plate 4 is inserted in the path of a beam 2a, which makes the linearly polarized light circularly polarized. The light beam 2a is then guided onto optical gratings 5, which are used to fan the beam into its components according to wavelength. These components are parallelized by lenses 6 and then guided to a modulator 7, which in this example is a rotating disc, as shown in more detail in FIGS. 4 and 5. With the rotating disc, the spectral components of the guided light of different wavelengths λ₁, λ₂, λ₃, . . . λiᵢ₋₁, λᵢ, because they are differently spaced in the radial direction of the disc, are modulated, and reflected back to the lenses 6 with different frequencies f₁, f₂, . . . fᵢ₋₁, fᵢ. The components return through the lenses 6 and reconstitute themselves in a fan-like shape and reach the optical gratings 5. The components of the reflected light, which is the same as the incident beam 2 but travels in the opposite direction, are combined with the optical grating 5 to return the excitation laser beam, but in this each λ^{f1}₁, λ^{f2}₂, Δ^{f3}₃, . . . λ^{fi-1}ᵢ₋₁, λ^{fi}ᵢ spectral components are already modulated at different frequencies, and the total laser light beam intensity varies in a time-complex manner according to the superposition of the different frequencies. This laser beam 2b is again passed through the quarter-wave plates 4, producing linearly polarized light. However, this light is of orthogonal polarity to the beams 2 produced by light source 1, so the reflected light is deflected by 90° by beam splitter 3. Samples 8 not shown in detail are illuminated with this light. To examine the light scattered from the illuminated sample 8, a simple single-channel detector, such as a photodiode, is used instead of a spectrometer, as is the usual procedure. In the Raman spectrum excited by the modulated output beam, and thus in the light detected by the single-channel detector 9 after the bandpass filter 10 placed downstream of the detector 9, complex modulation will also appear, i.e. the wavenumber ranges of the Raman spectrum corresponding to the Raman shifts v_{Raman-1}>v_{Raman-2}, v_{Raman-3}, . . . v_{Raman-i-1}, v_{Raman-i} will be modulated with different frequencies. In the case of the very narrow bandpass filter 10 shown in FIG. 2, each arrow corresponds to a v_{Raman-1}, v_{Raman-2}, v_{Raman-3}, . . . v_{Raman-i-1}, v_{Raman-i} energy transition, and if there is a V_{Raman-n} Raman transition or oscillation in the sample 8 that can be excited by it, there will be a signal in the detector behind the bandpass filter 10, whereas, if there is an energy difference that cannot be excited by it, there will be no signal. If the dashed line v_{Raman-n} arrow is a working vibrational transition, then a signal is obtained only at the v_{Raman-n} wavenumber of the dashed line arrow after the bandpass filter 10. For a composite spectrum, e.g., where there are several peaks in the range, then more working vibrational transitions would be detected by analogy. By Fourier transforming the time-domain signal emitted by the detectors 9, the frequency components and their intensities in the Raman scattered light can be extracted, and by knowing the modulation frequencies associated with each component of the excitation laser beam, the relative wavenumber of the Raman shifts to which these components belong can be determined, and the Raman spectrum can be reconstructed. This eliminates the need for a dispersive element, a spectrometer, which is used in known techniques, and ultimately a complicated and expensive measurement setup. For example, the method allows to measure and obtain the Raman shift efficiently and in a short time by inserting the single channel detector 9 with the bandpass filters in one objective.

FIG. 4 shows an example embodiment of the rotary disk modulator 7 used in the embodiment shown. As shown in detail in FIG. 5, concentric rings 12 are formed on the disc 11 of the modulator 7, in which different numbers of alternating reflective-non-reflective sections 13 are formed. The period, i.e., the frequency, of the rings 12 varies with a fixed value per ring 12 in the radial direction of the disc 11.

The possible measuring range is determined by the spectral width of the beams 2 of the excitation laser and the characteristics of the bandpass filters 10, while the resolution is determined by the modulators 7, i.e., the number of modulation components with different frequencies and the characteristics of the bandpass filters 10. For a typical excitation laser with a wavelength of 635 nm and a bandwidth of 0.8 nm, the Raman shift range covered by beams 2 of light is 20 cm⁻¹, and a resolution of 1 cm⁻¹ can be achieved by modulating the laser light at 20 frequencies. At a wavelength of 785 nm and a bandwidth of 0.8 nm, this translates to 0.6 cm⁻¹. In Raman spectroscopy, both values are very good, so the spectral resolution achievable with this method and the equipment that implements it is comparable to that of Raman spectrometers used for research purposes, which is around 1 cm⁻¹, but instead of a complicated optical system and detection, it can all be built from a few optical elements.

One of the advantages of our method is that it can be implemented with a low-cost laser light source with a large spectral width, since the larger the bandwidth of the laser light source, the larger the spectral range that can be used in Raman spectroscopy, the more modulation can be achieved, and the better the detection efficiency. An additional advantage is that only a single-channel detector is needed because the resolution of the spectral components is not performed on the scattered light but on the excitation laser beam with the multichannel modulator.

The shortcoming of the proposed solution is that the spectral bandwidth is limited by the bandwidth of the excitation laser, so the technique is most suitable for high-resolution analysis of narrow Raman bands, e.g., for the detection of DNA hybridization by Raman spectroscopy, for the qualification of silicon wafers in the semiconductor industry, etc.

Modulation of components at different frequencies can be achieved by other known methods, such as micro-electro-mechanical, MEMS, spatial light modulators, SLM, or liquid crystal matrix, in addition to the rotating disk method.

In addition to the multi-frequency modulation described above, a similar measurement can be made by varying the wavelength of the excitation laser and measuring the signal at each temperature in parallel with the bandpass filter and single-channel detector.

1. A Raman spectroscopic method using single-channel detection without dispersion element, detecting the spectrum of light scattered from a sample (8) excited by monochromatic light having wavelength different from the latter, and comprising:
modulating spectral components of a monochromatic excitation beam (2) with a spectral bandwidth covering the Raman shift range to be measured with different frequencies between 100 Hz and 10 MHz;
detecting temporal variation of the Raman scattering excited by this beam (2) behind a spectral bandpass filter (10) with a bandwidth narrower than the spectral bandwidth of the excitation beam (2), which transmits only those components of the Raman scattered light that fall within the transmission wavelength region of the filter (10); and
performing Fourier transformation of the measured signal to reproduce a Raman spectrum with a high spectral resolution, typically below half a wavenumber.

2. The method according to claim 1, wherein for measuring the spectrum and separating the spectral components, each spectral component of the excitation beam (2) is distinguished such that the excitation beam (2) is split into its spectral components by an optical grating (5), the obtained light beam (2a), which contains light resolved in wavelength in the horizontal direction, is focused onto a disc (11) having a periodic pattern of alternating reflecting and transmitting regions in concentric rings (12) with different repetition periods;
wherein when the disc (11) is rotated, the components of the light beam (2a) are reflected or transmitted depending on the regions of the disc (11), and the intensity of a light beam (2a) is continuously and periodically modulated;
wherein the components of the reflected light, travelling in the direction being opposite to the incident light beam (2a), are combined with the optical grating (5) to form an excitation laser beam (2b) that contains each spectral component modulated at a different frequency, the Raman spectrum excited by the modulated output beam (2b) is passed through a band-pass filter (10);
wherein the light beam transmitted through the bandpass filter (10) is detected by a single-channel detector (9);
wherein a Fourier transform is performed on the time-domain signal recorded by the detector (9) to extract the frequency components and their intensities in the Raman-scattered spectrum, the modulation frequencies of each wavelength component of the excitation laser beam (2) are used to determine the relative wavenumber of the Raman shifts to which the components belong to, and thus to reconstruct the Raman spectrum.

3. A device for performing Raman spectroscopy comprising:
a monochromatic excitation light source (1) comprising a laser light source (1) with a spectral band-width covering the spectral range of the Raman shifts to be measured;
a modulator (7) modulating the different wavelength components of the monochromatic laser beam (2) emitted by the light source (1) at different frequencies;
a single-channel detector (9) being a part of an optical unit directing the modulated laser light to a sample (8) and collecting the light scattered by the sample (8), and sampling the scattered light at a rate of at least twice the maximum modulation frequency;
band-pass filter (10) with a spectral bandwidth narrower than the excitation laser beam (2), where the band-pass filter (10) is arranged in front of the detector (9), and is transparent in the spectral range of the Raman shifts to be measured; and
an arithmetic unit that reproduces a Raman spectrum with high spectral resolution by performing a Fourier transform on the measured signal.

4. The device according to claim 3, wherein the laser light beam (2) produced by the light source (1) is directed onto the sample (8) by the optical element comprising a polarization-dependent beam splitter (3) arranged in the path of the laser light beam (2) emitted by the light source (1), a quarter-wave plate (4) converting the linearly polarized laser light beam (2) exiting the beam splitter (3) into a circularly polarized light, downstream of the optical quarter-wave plate (4) in the direction of travel of the light beam (2), an optical grating (5) which splits the light into its components according to wavelength, a lens (6) which makes parallel the light components emerging from the optical grating in a fan-like shape and delivers them to the modulator (7).

5. The device according to claim 3, wherein the modulator (7) is arranged in concentric rings (12) as a rotary disc (11) composed of a different number of alternating reflecting-non-reflecting sections (13) per ring (12).

6. The device according to claim 5, wherein the modulator (7) is configured as a matrix of tiltable micromirrors, in particular as a matrix tiltable parallel micromirror with different frequencies per mirror.

7. The device according to claim 3, wherein the bandpass filter (10) is implemented as an interference filter, a combination of a low-pass filter and a high-pass filter, a spatial spectral filter, a photonic crystal, and a virtually mapped phase matrix.

8. The device according to claim 4, wherein the modulator (7) is arranged in concentric rings (12) as a rotary disc (11) composed of a different number of alternating reflecting-non-reflecting sections (13) per ring (12).

9. The device according to claim 8, wherein the modulator (7) is configured as a matrix of tiltable micromirrors, in particular as a matrix tiltable parallel micromirror with different frequencies per mirror.

10. The device according to claim 4, wherein the bandpass filter (10) is implemented as an interference filter, a combination of a low-pass filter and a high-pass filter, a spatial spectral filter, a photonic crystal, and a virtually mapped phase matrix.
